(19) United States
(12) Patent Application Publication
(10) Pub. No.: US 2014/0365368 A1
(43) Pub. Date: Dec. 11, 2014

(54) SYSTEMS AND METHODS FOR BLOCKING CLOSED ACCOUNT TRANSACTIONS

(71) Applicant: MasterCard International Incorporated, Purchase, NY (US)

(72) Inventors: Sharon A. Rosano, New Canaan, CT (US); Richard Rozbicki, Danbury, CT (US); Timothy Tudor Hopkins, Ballwin, MO (US)

(21) Appl. No.: 13/915,339

(22) Filed: Jun. 11, 2013

(51) Int. Cl. G06Q 20/34

(52) U.S. Cl. CPC G06Q 20/354
USPC 705/44

(57) ABSTRACT

A method for denying a payment transaction initiated by a user using a payment card associated with a blocked account is provided. The method may be implemented by a computing device coupled to a memory device. The method includes receiving by the computing device a request to block an account number from being used in connection with payment transactions, and storing the account number in the memory device as a blocked account number. The method also involves receiving by the computing device a request to verify that a new payment transaction as not being associated with a blocked account number, the verification request including a candidate account number. The method also comprises comparing the candidate account number with the blocked account number stored in the memory device, and denying verification of the new payment transaction when at least a portion of the candidate account number matches the blocked account number.

### BACKGROUND OF THE INVENTION

The field of the invention relates generally to systems and methods for processing payment transactions, and more particularly, to systems and methods for denying payment transactions associated with blocked account numbers.

Fraudulent and otherwise undesirable payment card activity costs the payment card industry significant money, good will, and consumer confidence. Because recovery of stolen property from the perpetrator of fraudulent activity typically does not occur, the participants in the payment card industry often must pay for the loss.

To prevent these losses, the payment card industry uses a number of methods to protect payment cards from being used in fraudulent activity. For example, payment cards may require that physical identification, or a security code, be given to the merchant at the time of purchase. However, in some instances, these protections are inadequate. In particular, some payment accounts associated with payment cards, including, but not limited to: dormant accounts, newly created but not yet live accounts, and accounts associated with discontinued bank identification numbers (BINs) are still frequent targets of fraudulent activity.

At least some methods of denying suspicious payment transactions in foreign countries or for large and unusual amounts are known. Methods of denying payment transactions associated with payment cards that are being used nearly simultaneously in separate geographical areas are also known. However, none of the known methods for denying payment transactions are capable of denying a new payment transaction based on a comparison between a blocked account number and an account number associated with a new payment transaction. Therefore, there remains a need to block payment transactions from particular payment accounts associated with payment cards.

### BRIEF DESCRIPTION OF THE INVENTION

In one aspect, a method for denying a payment transaction initiated by a user using a payment card associated with a blocked account is provided. The method may be implemented by a computing device coupled to a memory device. The method includes receiving by the computing device a request to block an account number from being used in connection with payment transactions, and storing the account number in the memory device as a blocked account number. The method also involves receiving by the computing device a request to verify a new payment transaction as not being associated with a blocked account number, the verification request including a candidate account number. The method also includes comparing the candidate account number with the blocked account number stored in the memory device, and denying new payment transaction when at least a portion of the candidate account number matches the blocked account number.

In another aspect, a network-based system for denying a payment transaction initiated by a user using a payment card associated with a blocked account is provided. The network-based system comprises a payment network including a memory device and a computing device coupled to the memory device. The computing device is configured to receive a request to block an account number from being used in connection with payment transactions, and store the blocked account number in the memory device. The computing device is also configured to receive a request to verify a new payment transaction as not being associated with a blocked account number, wherein the verification request includes a candidate account number. The computing device is also configured to compare the candidate account number to the blocked account number stored in the memory device, and to deny the new payment transaction when at least a portion of the candidate account number matches the blocked account number.

In another embodiment a non-transitory computer readable medium having computer-executable instructions for denying a payment transaction initiated by a user using a payment card associated with a blocked account embodied thereon is provided. When the instructions are executed by at least one processor, the instructions cause the processor to: receive a request to block an account number from being used in connection with payment transactions, and store the blocked account number in a memory device. The computer-executable instructions also cause the processor to receive a request to verify a new payment transaction as not being associated with a blocked account, wherein the verification request includes a candidate account number. The computer-executable instructions also cause the processor to compare the candidate account number to the blocked account number stored in the memory device, and to deny the new payment transaction when at least a portion of the candidate account number matches the blocked account number.

In another embodiment a computer system for denying a payment transaction initiated by a user using a payment card associated with a blocked account is provided. The system comprises a memory device, a computing device coupled to the memory device, and an account number blocking module coupled to the computing device. The account number blocking module is configured to receive a request to block an account number from being used in connection with payment transactions, and store the blocked account number in the memory device. The account number blocking module is also configured to receive a request to verify a new payment transaction as not being associated with a blocked account number, wherein the verification request includes a candidate account number. The account number blocking module is further configured to compare the candidate account number to the blocked account number stored in the memory device, and to deny the new payment transaction when at least a portion of the candidate account number matches the blocked account number.

### BRIEF DESCRIPTION OF THE DRAWINGS

FIGS. 1-6 show example embodiments of the methods and systems described herein.

FIG. 1 shows a system of interrelated steps describing a conventional payment card initiated payment transaction.

FIG. 2 is a simplified block diagram of an example payment system with a server architecture in communication with an account number blocking module.

FIG. 3 is an expanded block diagram of an example processing system with a server architecture in communication with an account number blocking module.

FIG. 4 illustrates an example configuration of a client system as shown in FIGS. 2 and 3.

FIG. 5 illustrates an example configuration of a server system as shown in FIGS. 2 and 3 coupled to an account number blocking module.

FIG. 6 is a simplified flowchart illustrating an example process implemented by the payment system shown in FIGS. 2 and 3 for denying a payment transaction initiated by a user using a payment card associated with a blocked account.

### DETAILED DESCRIPTION OF THE INVENTION

Described in detail herein are example embodiments of systems and methods that facilitate denying payment transactions initiated by a user using a payment card associated with a blocked account. More specifically, a payment system comprising an account number blocking module in communication with a server system implements a process to verify a payment card transaction as not being associated with a blocked account number. The account number blocking module may be configured to receive an account number to block from being used in connection with payment transactions, and store the account number to be blocked in a memory device as one of a plurality of blocked account numbers. The account number blocking module is also configured to verify a payment transaction as not being associated with a blocked account number by comparing a candidate account number associated with the payment transaction with the plurality of blocked account numbers. The account number blocking module is also configured to deny the payment transaction when at least a portion of the candidate account number matches one of the blocked account numbers. The account number blocking module is configured to verify a new payment transaction as part of at least one of an authorization request and a clearance request.

A technical effect of the systems and methods described herein include at least one of (a) receiving a request to block an account number from being used in connection with payment transactions; (b) storing the account number in a memory device as one of a plurality of blocked account numbers; (c) receiving a request to verify a new payment transaction as not being associated with a blocked account number, the verification request including a candidate account number; (d) comparing the candidate account number to the plurality of blocked account numbers stored in the memory device; and (e) denying the new payment transaction when at least a portion of the candidate account number matches one of the plurality of blocked account numbers stored in the memory device.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, tablets, and/or computers. Each type of transaction card can be used as a method of payment for performing a payment transaction. In addition, cardholder account behavior can include, but is not limited to purchases, management activities (e.g., balancing checking accounts), bill payments, achievement of targets (e.g., meeting account balance goals, paying bills on time), and/or product registrations (e.g., mobile application downloads).

As used herein, the term “payment transaction,” “financial transaction” or “transaction” refers to any suitable payment transaction, such as a credit card transaction, debit card transaction, gift card transaction, charge card transaction, or any other transaction in which some value or credit is transferred from an account associated with a user to an account associated with a merchant.

As used herein, the term “account number” refers to any number that may be used to identify either an individual payment card or a group of payment cards. For example, payment cards may be identified by their primary account numbers (PANs) or bank identification numbers (BINs). A PAN is usually a 16-digit number associated with an individual payment card, though more or less digits may be used. A BIN is the first portion of a PAN and generally identifies the issuer of the payment card. The BIN is typically the first six digits of a PAN, though more or less digits may be used. The issuer may be associated with multiple individual payment cards that share the same BIN. In addition to the BIN, a PAN may include an individual account identifier. The individual account identifier may be of a variable length and generally serves to identify the individual account associated with a payment card.

As used herein, the term “card-present transaction” refers to a transaction in which a cardholder's payment card is present at the time the transaction is initiated. For example, when a consumer purchases groceries at a supermarket by swiping a credit card, this transaction is a card-present transaction because the cardholder, i.e., the consumer, has their payment card, i.e., the credit card, present at the time of the transaction.

As used herein, the term “card-not-present transaction” refers to a transaction in which a cardholder's payment card is not necessarily present at the time the transaction is initiated, but instead, the cardholder's account is identified without use of the physical payment card. For example, a consumer/cardholder purchasing a product or service by telephone or from a merchant's internet web site may provide their account information over the phone to the merchant's representative or enter the information directly into the merchant's webs site. The merchant then initiates a transaction for the product or service using the account information entered by the consumer, without the payment card in the presence of the merchant. In addition, the card-not-present transaction may be a recurring transaction. For example, a consumer/cardholder may purchase a product or service from a merchant, or a merchant's website, and store their payment card information with the merchant. The merchant may use the stored payment card information on a periodic basis to initiate a card-not-present transaction.

The following detailed description illustrates embodiments of the invention by way of example and not by way of limitation. It is contemplated that the invention has general application to processing financial transaction data by a third party. However, this disclosure is not intended to be limited to the embodiments described herein, but could be used in various other embodiments that are also covered by this disclosure.

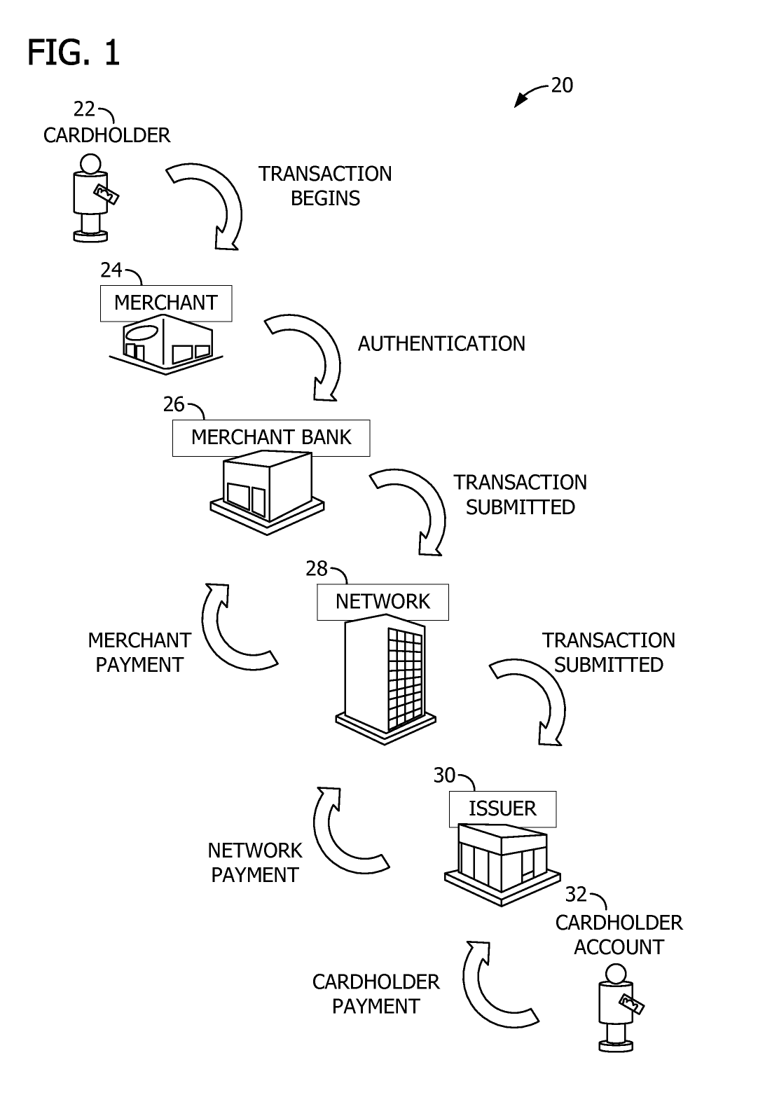

FIG. 1 is a schematic diagram illustrating an example multi-party transaction card industry system 20 for enabling ordinary payment-by-card transactions in which merchants 24 and card issuers 30 do not need to have a one-to-one special relationship. Embodiments described herein may relate to a transaction card system, such as the payment card network operated by MasterCard International Incorporated, the assignee of the present disclosure. Such a network is comprised, in part, of a set of proprietary communications standards and protocols for the exchange of financial transaction data and the settlement of funds between financial institutions that are members of the payment network.

In a typical transaction card system, a financial institution called the “issuer” 30 issues a transaction card, such as a credit card, to a consumer or cardholder 22, who uses the transaction card to tender payment for a purchase from a merchant 24. To accept payment with the transaction card, merchant 24 must normally establish an account with a financial institution that is part of the financial payment system. This financial institution is usually called the “merchant bank,” the “acquiring bank,” or the “acquirer.” When cardholder 22 tenders payment for a purchase with a transaction card, merchant 24 requests authorization from a merchant bank 26 for the amount of the purchase. The request may be performed over the telephone, but is usually performed through the use of a point-of-sale (POS) terminal, which reads cardholder's 22 account information from a magnetic stripe, a chip, or embossed characters on the transaction card that may be manually inputted into the POS terminal, and communicates electronically with the transaction processing computers of merchant bank 26. Alternatively, merchant bank 26 may authorize a third party to perform transaction processing on its behalf In this case, the point-of-sale terminal will be configured to communicate with the third party. Such a third party is usually called a “merchant processor,” an “acquiring processor,” or a “third party processor.”

Using a payment network 28, computers of merchant bank 26 or merchant processor will communicate with computers of an issuer bank 30 to determine whether the payment transaction should be authorized. This may include a number of factors such as, whether cardholder's 22 account 32 is in good standing, and whether the purchase is covered by cardholder's 22 available credit line. If the request is accepted, an authorization code is issued to merchant 24.

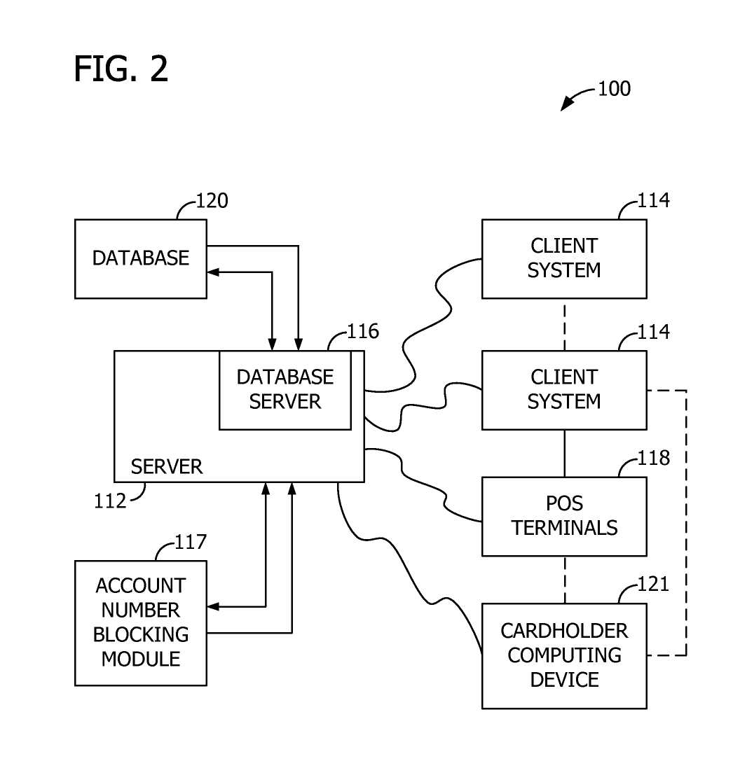

When a request for authorization is accepted, the available credit line of cardholder's 22 account 32 is decreased. In some cases, a charge for a payment card transaction may not be posted, i.e., “captured” immediately to cardholder's 22 account 32, whereas in other cases, especially with respect to at least some debit card transactions, a charge may be posted or captured at the time of the transaction. In some cases, when merchant 24 ships or delivers the goods or services, merchant 24 captures the transaction by, for example, appropriate data entry procedures on the POS terminal This may include bundling of approved transactions daily for standard retail purchases. If cardholder 22 cancels a transaction before it is captured, a “void” is generated. If cardholder 22 returns goods after the transaction has been captured, a “credit” is generated. Payment network 28 and/or issuer bank 30 stores the transaction card information, such as a type of merchant, amount of purchase, date of purchase, in a database 120 (shown in FIG. 2).

For debit card transactions, when a request for a PIN authorization is approved by the issuer, the consumer's account is decreased. Normally, a charge is posted immediately to a consumer's account. The issuer 30 then transmits the approval to the merchant bank 26 via the payment network 28, with ultimately the merchant 24 being notified for distribution of goods/services, or information or cash in the case of an ATM.

After a purchase has been made, a clearing process occurs to transfer additional transaction data related to the purchase among the parties to the transaction, such as merchant bank 26, payment network 28, and issuer bank 30. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction. In the example embodiment, when cardholder 22 purchases travel, such as airfare, a hotel stay, and/or a rental car, at least partial itinerary information is transmitted during the clearance process as transaction data. When payment network 28 receives the itinerary information, payment network 28 routes the itinerary information to database 120 (shown in FIG. 2).

After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction is typically settled between issuer bank 30 and payment network 28, and then between payment network 28 and merchant bank 26, and then between merchant bank 26 and merchant 24.

FIG. 2 is a simplified block diagram of an example payment system 100 including a plurality of computer devices, such as server system 112, client systems 114, account number blocking module 117, and cardholder computing device 121. In one embodiment payment system 100 implements a process to validate a payment card transaction. More specifically, account number blocking module 117 in communication with server system 112 is configured to receive an account number to block from being used in connection with payment transactions, and store the account number to be blocked in a memory device as one of a plurality of blocked account numbers. Account number blocking module 117 is also configured to verify a payment transaction as not being associated with a blocked account number by comparing a candidate account number associated with the payment transaction with the plurality of blocked account numbers. Account number blocking module 117 is further configured to deny the payment transaction when at least a portion of the candidate account number matches one of the blocked account numbers.

More specifically, in the example embodiment, system 100 includes a server system 112, and a plurality of client sub-systems, also referred to as client systems 114, connected to server system 112. In one embodiment, client systems 114 are computers including a web browser, such that server system 112 is accessible to client systems 114 using the Internet. Client systems 114 are interconnected to the Internet through many interfaces including a network, such as a local area network (LAN) or a wide area network (WAN), dial-in-connections, cable modems, and special high-speed Integrated Services Digital Network (ISDN) lines. Client systems 114 could be any device capable of interconnecting to the Internet including a web-based phone, PDA, or other web-based connectable equipment.

System 100 also includes point-of-sale (POS) terminals 118, which may be connected to client systems 114, may be connected to server system 112, and may be connected to cardholder computing device 121. POS terminals 118 are interconnected to the Internet through many interfaces including a network, such as a local area network (LAN) or a wide area network (WAN), dial-in-connections, cable modems, wireless modems, and special high-speed ISDN lines. POS terminals 118 could be any device capable of interconnecting to the Internet and including an input device capable of reading information from a consumer's financial transaction card.

A database server 116 is connected to database 120, which contains information on a variety of matters, as described below in greater detail. In one embodiment, centralized database 120 is stored on server system 112 and can be accessed by potential users at one of client systems 114 by logging onto server system 112 through one of client systems 114. In an alternative embodiment, database 120 is stored remotely from server system 112 and may be non-centralized.

Database 120 may include a single database having separated sections or partitions or may include multiple databases, each being separate from each other. Database 120 may store transaction data generated as part of sales activities conducted over the processing network, including data relating to merchants, account holders or customers, issuers, acquirers, and/or purchases made. Database 120 may also store account data including at least one of a cardholder name, a cardholder address, an account number, and other account identifier. Database 120 may also store merchant data including a merchant identifier that identifies each merchant registered to use the network, and instructions for settling transactions including merchant bank account information. Database 120 may also store purchase data associated with items being purchased by a cardholder from a merchant, and authorization request data. Database 120 may also store a plurality of blocked account numbers.

In the example embodiment, one of client systems 114 may be associated with acquirer bank 26 (shown in FIG. 1) while another one of client systems 114 may be associated with issuer bank 30 (shown in FIG. 1). POS terminal 118 may be associated with a participating merchant 24 (shown in FIG. 1). Server system 112 may be associated with payment network 28. In the example embodiment, server system 112 is associated with a network, such as payment network 28, and may be referred to as a payment computer system. Server system 112 may be used for processing transaction data. Server system 112 may be in communication with account number blocking module 117. Account number blocking module 117 may be configured to receive account numbers to block from being used in connection with payment transactions, store the account numbers to be blocked in a memory device as blocked account numbers, verify a payment transaction by comparing a candidate account number associated with the payment transaction with the blocked account numbers, and deny the payment transaction when at least a portion of the candidate account number matches one of the blocked account numbers. In addition, client systems 114 and/or POS terminal 118 may include a computer system associated with at least one of an online bank, a bill payment outsourcer, an acquirer bank, an acquirer processor, an issuer bank associated with a transaction card, an issuer processor, a remote payment system, and/or a biller.

In the example embodiment, account number blocking module 117 may be implemented for all payment transactions. For example, the server system 112 may automatically communicate with the account number blocking module for a new payment transaction. In some embodiments, account number blocking module 117 may be implemented only for certain transactions. More specifically, the cardholder 22 or issuer 30 may register a payment card for use with account number blocking module 117. In such an embodiment, server system 112 may check if a payment card is registered for the account number blocking module service before communicating with account number blocking module 117.

In the example embodiment, account number blocking module 117 may be a computing device in communication with server system 112. In another embodiment, account number blocking module 117 may be a part of server system 112. In such an embodiment, server system 112 is configured to perform the functions ascribed herein to the account number blocking module 117. In another embodiment, account number blocking module 117 may be a stand-alone device comprising a processor and a memory unit. In such an embodiment, the account number blocking module 117 is programmed to perform the functions described herein without communicating with server system 112.

System 100 may include a cardholder computing device 121. Cardholder computing device 121 may be a computer device and/or mobile device used by a cardholder making an on-line purchase or payment, such as a computer, smartphone, PDA, tablet, or any other device capable of performing the functions described herein. In the example embodiment, cardholder computing device 121 includes a memory device and a computing device in communication with the memory device and may be communicatively coupled to POS terminal 118, server system 112 and client systems 114.

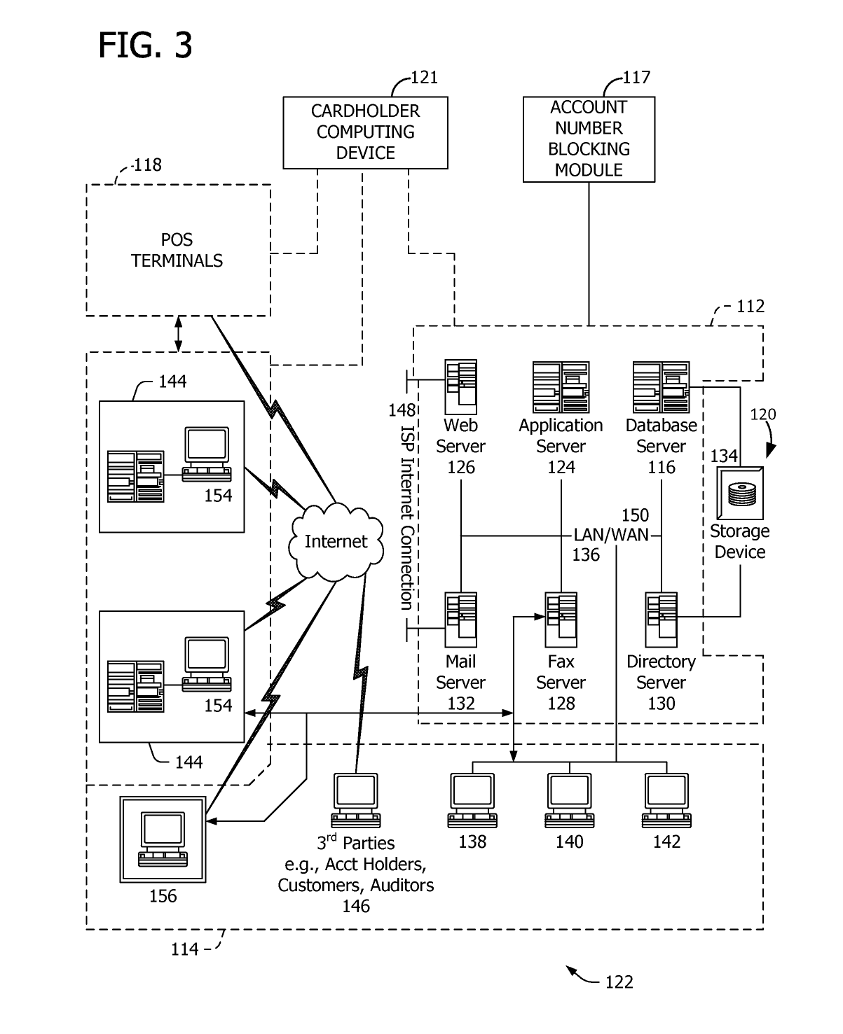

FIG. 3 is an expanded block diagram of an example server architecture of processing system 122 including other computer devices in accordance with one embodiment of the present invention. Processing system 122 comprises components identical to components of payment system 100 (shown in FIG. 2), those components are identified in FIG. 3 using the same reference numerals as used in FIG. 2. Processing system 122 includes server system 112, client systems 114, account number blocking module 117, POS terminals 118, and cardholder computing device 121. Server system 112 further includes database server 116, an application server 124, a web server 126, a fax server 128, a directory server 130, and a mail server 132. A storage device 134 is coupled to database server 116 and directory server 130. Servers 116, 124, 126, 128, 130, and 132 are coupled in a local area network (LAN) 136. In addition, a system administrator's workstation 138, a user workstation 140, and a supervisor's workstation 142 are coupled to LAN 136. Alternatively, workstations 138, 140, and 142 are coupled to LAN 136 using an Internet link or are connected through an Intranet.

Account number blocking module 117 may be in communication with server system 112 through any suitable network communication method including, but not limited to, Wide Area Network (WAN) 150 type communications, LAN 136 type communications, 3G type communications, or

Worldwide Interoperability for Microwave Access (WIMAX) type communications. Account number blocking module 117 may be configured to receive account numbers to block from being used in connection with payment transactions, store the account numbers to be blocked in a memory device as blocked account number, verify a payment transaction as not being associated with a blocked account number by comparing a candidate account number associated with the payment transaction with the blocked account numbers, and deny the payment transaction when at least a portion of the candidate account number matches one of the blocked account numbers.

Cardholder computing device 121 may be in communication with server system 112, POS terminal 118, and client systems 114 through any suitable network communication method including, but not limited to, WAN 150 type communications, LAN 136 type communications, 3G type communications, or WIMAX type communications.

Each workstation 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Server system 112 is configured to be communicatively coupled to various individuals, including employees 144 and to third parties, e.g., account holders, customers, auditors, developers, consumers, merchants, acquirers, issuers, etc., 146 using an ISP Internet connection 148. The communication in the example embodiment is illustrated as being performed using the Internet and a WAN type communication, however, any other type communication can be utilized in other embodiments, i.e., the systems and processes are not limited to being practiced using the Internet. In addition, rather than WAN 150, LAN 136 could be used.

In the example embodiment, any authorized individual having a workstation 154 can access processing system 122. At least one of the client systems 114 includes a manager workstation 156 located at a remote location. Workstations 154 and 156 are personal computers having a web browser. Also, workstations 154 and 156 are configured to communicate with server system 112. Furthermore, fax server 128 communicates with remotely located client systems, including a client system 156 using a telephone link. Fax server 128 is configured to communicate with other client systems 138, 140, and 142 as well.

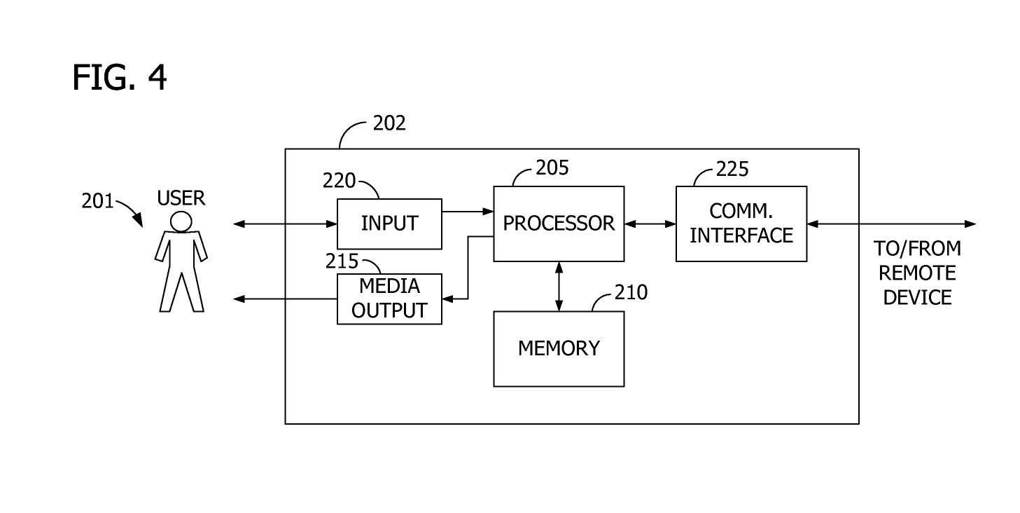

FIG. 4 illustrates an example configuration of a user system 202 operated by a user 201, such as cardholder 22 (shown in FIG. 1). User system 202 may include, but is not limited to, cardholder computing device 121, client systems 114, 138, 140, and 142, POS terminal 118, workstation 154, and manager workstation 156. In the example embodiment, user system 202 includes a processor 205 for executing instructions. In some embodiments, executable instructions are stored in a memory area 210. Processor 205 may include one or more processing units, for example, a multi-core configuration. Memory area 210 is any device allowing information, such as executable instructions and/or written works, to be stored and retrieved. Memory area 210 may include one or more computer readable media.

User system 202 also includes at least one media output component 215 for presenting information to user 201. Media output component 215 is any component capable of conveying information to user 201. In some embodiments, media output component 215 includes an output adapter such as a video adapter and/or an audio adapter. An output adapter is operatively coupled to processor 205 and operatively couplable to an output device such as a display device, a liquid crystal display (LCD), organic light emitting diode (OLED) display, or “electronic ink” display, or an audio output device, such as a speaker or headphones.

In some embodiments, user system 202 includes an input device 220 for receiving input from user 201. Input device 220 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 215 and input device 220. User system 202 may also include a communication interface 225, which is communicatively couplable to a remote device such as server system 112. Communication interface 225 may include, for example, a wired or wireless network adapter or a wireless data transceiver for use with a mobile phone network, Global System for Mobile communications (GSM), 3G, or other mobile data network such as WIMAX.

Stored in memory area 210 are, for example, computer readable instructions for providing a user interface to user 201 via media output component 215 and, optionally, receiving and processing input from input device 220. A user interface may include, among other possibilities, a web browser and client application. Web browsers enable users, such as user 201, to display and interact with media and other information typically embedded on a web page or a website from server system 112. A client application allows user 201 to interact with a server application from server system 112.

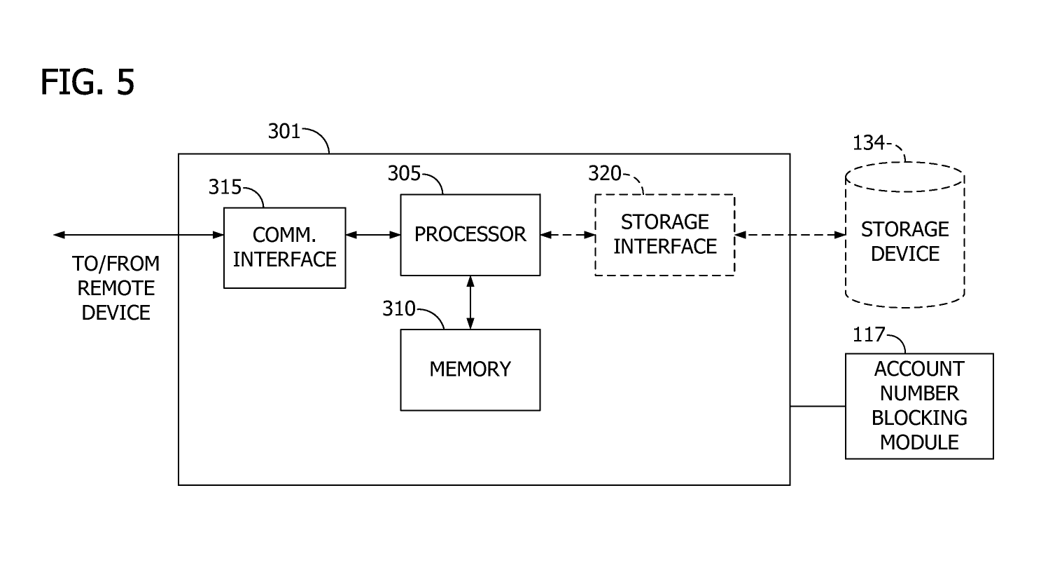

FIG. 5 illustrates an example configuration of a server system 301 such as server system 112 (shown in FIGS. 2 and 3). Server system 301 may include, but is not limited to, database server 116, application server 124, web server 126, fax server 128, directory server 130, and mail server 132.

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX®, LINUX®, Microsoft Windows®, etc. (Windows is a registered trademark of Microsoft Corporation, Redmond, Wash.; UNIX is a registered trademark of X/Open Company Limited located in Reading, Berkshire, United Kingdom; LINUX is a registered trademark of Linus Torvalds, San Francisco Calif.). It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Server system 301 may be communicatively coupled to account number blocking module 117. Account number blocking module 117 in communication with server system 112 is configured to receive an account number to block from being used in connection with payment transactions, and store the account number to be blocked in a memory device as one of a plurality of blocked account numbers. Account number blocking module 117 is also configured to verify a payment transaction as not being associated with a blocked account number by comparing a candidate account number associated with the payment transaction with the plurality of blocked account numbers. Account number blocking module 117 is further configured to deny the payment transaction when at least a portion of the candidate account number matches one of the blocked account numbers. In the example embodiment, account number blocking module 117 may be external to server system 301 and may be accessed by multiple server systems 301. For example, account number blocking module 117 may be a computing device coupled to a memory unit. In some embodiments, account number blocking module 117 may be integrated with server system 301. For example, account number blocking module may be a specifically programmed section of server system 301 configured to perform the functions described herein when executed by processor 305.

Processor 305 is operatively coupled to a communication interface 315 such that server system 301 is capable of communicating with a remote device such as a user system or another server system 301. For example, communication interface 315 may receive requests from client system 114 and cardholder computing device 121 via the Internet, as illustrated in FIGS. 2 and 3.

Processor 305 may be operatively coupled to a storage device 134. Storage device 134 is any computer-operated hardware suitable for storing and/or retrieving data. In some embodiments, storage device 134 is integrated in server system 301. For example, server system 301 may include one or more hard disk drives as storage device 134. In other embodiments, storage device 134 is external to server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of a computer program.

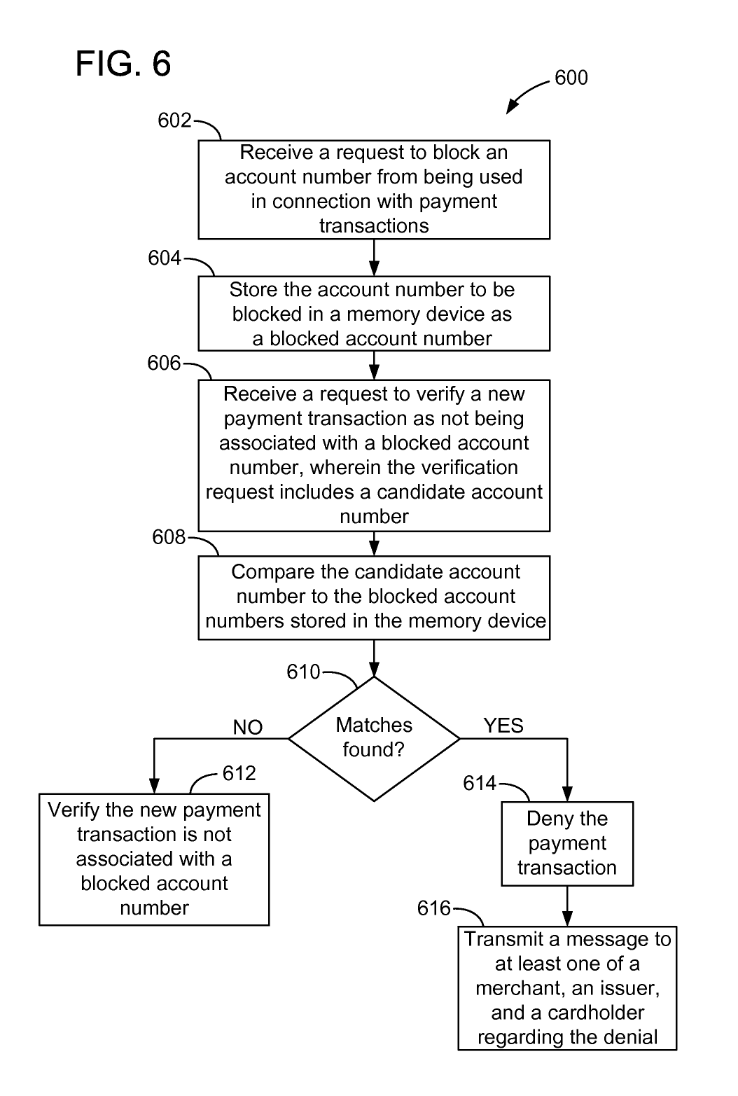

FIG. 6 is a simplified flowchart 600 illustrating an example process implemented by payment system 100 (as shown in FIG. 2) for denying a payment transaction initiated by a user using a payment card associated with a blocked account.

In an example embodiment, server system 112 (shown in FIG. 2) receives, at block 602, from issuer 30 or cardholder 22 (shown in FIG. 1), a request to block an account number associated with at least one payment card from being used in connection with payment transactions, and communicates the request to block the account number with account number blocking module 117. In at least one embodiment, the account number to be blocked may be a PAN. For example, when issuer 30 or cardholder 22 decides to disable an individual payment card, the PAN associated with the payment card may be sent from client systems 114 or cardholder computing device 121 to server system 112. In other embodiments, the account number to be blocked may be a BIN. When issuer 30 decides to disable multiple payment cards that share a single BIN, the BIN to be blocked may be sent to the account number blocking module 117 via server system 112 from one of client systems 114. As used herein, a “blocked account number” refers to an account number that server system 112 has received a request to prevent from being used in connection with payment transactions and has been communicated to account number blocking module 117. In the example embodiment, server system 112 is configured to receive at least one of a PAN and a BIN from client systems 114 or cardholder computing device 121 and to communicate the at least one of a PAN and a BIN to account number blocking module 117. The account number blocking module 117 stores the at least one of a PAN and a BIN in the memory device.

In the example embodiment, account number blocking module 117 in communication with server system 112 is configured to store, at block 604, the blocked account number in a memory device, such as database 120. In the example embodiment, the blocked account number may be one of a plurality of blocked account numbers stored in the memory device. The memory device may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are examples only, and are thus not limiting as to the types of memory usable for storage of a computer program.

Also in the example embodiment, server system 112 is configured to receive, at block 606, a request to verify a new payment transaction as not being associated with a blocked account number, wherein the verification request includes a candidate account number. In the example embodiment, server system 112 automatically communicates the candidate account number to the account number blocking module 117. In other embodiments, the server system 112 determines whether the payment card is registered with the account number blocking module service, and sends the candidate account number to the account number blocking module 117 only if the payment card is registered. In the example embodiment, the request to verify the new payment transaction is received from one of a merchant 24 and a merchant bank 26. In other embodiments, issuer 30 may request to verify the new payment transaction.

In at least one embodiment, the verification of the new payment transaction may be performed by account number blocking module 117 as part of an authorization request being processed by the payment network 28 (shown in FIG. 1). In such an embodiment, server system 112 is associated with payment network 28 and communicates with account number blocking module 117. Server system 112 is configured to process payment transactions, including communicating with account number blocking module 117 to verify the candidate account number associated with the payment transaction is not a blocked account number. The server system 112 is further configured to initiate the payment transaction if the account number blocking module 117 determines the candidate account number is not a blocked account number. Verifying payment transactions at the authorization stage prevents undesired payment transactions from entering the system.

In at least one other embodiment, the verification of the new payment transaction may be performed by account number blocking module 117 as part of a clearance request being processed by the payment network 28. In such an embodiment, server system 112 is associated with payment network 28 and communicates with account number blocking module 117. Server system 112 is configured to process payment transactions, including communicating with account number blocking module 117 to verify the candidate account number associated with the payment transaction is not a blocked account number. The server system 112 is further configured to clear the payment transaction if the account number blocking module 117 determines the candidate account number is not a blocked account number. Verifying payment transactions at the clearance stage ensures that all payment transactions are verified, including those that may have bypassed the authorization process. In the example embodiment, the verification of the new payment transaction may be performed by server system 112 in communication with account number blocking module 117 as part of both authorization and clearance requests being processed by payment network 28.

As used herein, the term “candidate account number” refers to an account number associated with a payment transaction initiated by a payment card that is under investigation regarding whether it has a corresponding blocked account number stored in the memory device. In the example embodiment, the candidate account number is the PAN associated with the payment card that initiated the payment transaction. In other embodiments, the candidate account number is only the BIN associated with the payment card that initiated the payment transaction.

The new payment transaction may be any type of payment transaction, including one of a card-present transaction, a card-not-present transaction, and a card-not-present transaction that is recurring.

Also in the example embodiment, account number blocking module 117 in communication with server system 112 is configured to compare, at block 608, the candidate account number to the blocked account numbers stored in the memory device. In the example embodiment, the candidate account number may be the PAN of the payment card associated with the new payment transaction. In other embodiments, the candidate account number may be the BIN of the payment card associated with the new payment transaction.

Further in the example embodiment, account number blocking module 117 is configured to determine, at block 610 whether a match exists between the candidate account number and the blocked account numbers. In at least one embodiment, a match is considered to exist only if the candidate account number directly corresponds to at least one of the blocked account numbers stored in the memory device. For example, when a PAN of the payment card associated with the new payment transaction corresponds to at least one of the blocked account numbers stored in the memory device, account number blocking module 117 determines that a match has been found. In the example embodiment, a match is considered to be found if at least a predetermined part of the candidate account number matches at least one of the blocked account numbers. For example, if the candidate account number is a 16 digit PAN and one of the blocked account numbers is a six digit BIN, a match may be found if a predetermined part of the 16 digit PAN corresponds to the six digit BIN of the blocked account number.

Also in the example embodiment, when at least a portion of the candidate account number matches the blocked account number, account number blocking module 117 may communicate the match to server system 112. Server system 112 may be configured to deny, at block 614, the new payment transaction based on the match. In the example embodiment, the decision to deny 614 a payment transaction may be based solely on the candidate account number matching one of the blocked account numbers stored in the memory device. If the candidate account number matches one of the blocked account numbers, the payment transaction will automatically be denied.

In other embodiments, server system 112 may be configured to deny, at block 614, a payment transaction only based in part on the candidate account number matching one of the blocked account numbers. For example, once a match is made between the candidate account number and one of the blocked account numbers, other criteria associated with the payment transaction may be analyzed to determine whether the payment transaction should be denied. The criteria analyzed may include, but is not limited to, the merchant identification code associated with the payment transaction, the payment transaction type, the amount associated with the payment transaction, whether the payment card has sufficient credit to complete the payment transaction, and/or the payment card's history with respect to similar payment transactions.

In the example embodiment, when the transaction is denied at block 614, the server system 112 is configured to send, at block 616, a message from the server system 112 to at least one of merchant 24, issuer 30, and cardholder 22 (as shown in FIG. 1) regarding the denial of the payment transaction. In the example embodiment, the message may be sent to cardholder 22 to inform cardholder 22 that the payment transaction has been denied. Also in the example embodiment, the message may be sent to merchant 24 so that merchant 24 does not convey any goods to cardholder 22. Further, in the example embodiment, the message may be sent to issuer 30 so that issuer 30 may contact cardholder 22 to verify the transaction, or so issuer 30 may inform cardholder 22 of possible fraudulent activity. Further in the example embodiment, the message may contain details regarding the denial including: the reason for the denial, when the account number associated with the payment card was stored in the memory device as a blocked account number, whether the account number associated with the payment card was blocked at the direction of issuer 30 or cardholder 22, or any combination thereof.

Also in the example embodiment, server system 112 may be configured to verify, at block 612, the new payment transaction when the account number blocking module 117 determines the candidate account number does not match any of the blocked account numbers. In such an embodiment the server system 112 may authorize the payment transaction, clear the payment transaction, or otherwise allow the payment process to continue.

While the invention has been described in terms of various specific embodiments, those skilled in the art will recognize that the invention can be practiced with modification within the spirit and scope of the claims. Specifically, though the embodiments described herein make reference to an account number blocking module 117 in communication with server system 112 and configured to perform certain functions; the disclosure contemplates that other devices or systems, such as server system 112, client systems 114, POS terminal 118, and cardholder computing device 121, may perform some or all of the functions ascribed to account number blocking module 117.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

In one embodiment, a computer program is provided, and the program is embodied on a computer readable medium. In an example embodiment, the system is executed on a single computer system, without requiring a connection to a sever computer. In a further example embodiment, the system is being run in a Windows environment. In yet another embodiment, the system is run on a mainframe environment and a UNIX server environment. The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

As will be appreciated based on the foregoing specification, the above-described embodiments of the disclosure may be implemented using computer programming or engineering techniques including computer software, firmware, hardware or any combination or subset thereof Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present invention are not intended to be interpreted as excluding the existence of additional embodiments that also incorporate the recited features.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for denying a payment transaction initiated by a user using a payment card associated with a blocked account, said method implemented by a computing device coupled to a memory device, said method comprising:
receiving by the computing device a request to block an account number from being used in connection with payment transactions;
storing the account number in the memory device as a blocked account number;
receiving by the computing device a request to verify a new payment transaction as not being associated with the blocked account number, the verification request including a candidate account number;
comparing the candidate account number to the blocked account number; and
denying the new payment transaction when at least a portion of the candidate account number matches the blocked account number.

2. A method in accordance with claim 1, the method further comprising receiving an authorization request from at least one of a merchant and a merchant bank, the authorization request including the request to verify the new payment transaction, the new payment transaction initiated by the user using the payment card.

3. A method in accordance with claim 1 the method further comprising receiving a clearance request from at least one of a merchant and a merchant bank, the clearance request including the request to verify the new payment transaction, the new payment transaction initiated by the user using the payment card

4. A method in accordance with claim 1 wherein receiving the request to block an account number includes receiving a request to block a PAN from at least one of an issuing bank and a cardholder associated with the payment card, and denying the new payment transaction includes denying the new payment transaction when the candidate account number matches the PAN.

5. A method in accordance with claim 1 wherein receiving the request to block the account number includes receiving a request to block a BIN from an issuing bank, and wherein denying the new payment transaction includes denying the new payment transaction when a first portion of the candidate account number matches the BIN.

6. A method in accordance with claim 1 wherein denying the new payment transaction includes denying the new payment transaction based solely on at least a portion of the candidate account number matching the blocked account number.

7. A method in accordance with claim 1 wherein receiving the request to verify the new payment transaction includes receiving a request to verify at least one of a card-present transaction, a card-not-present transaction, and a card-not-present transaction that is recurring.

8. A network-based system for denying a payment transaction initiated by a user using a payment card associated with a blocked account, said network-based system comprising:
a payment network comprising a memory device and a computing device coupled to the memory device, the computing device configured to:
receive a request to block an account number from being used in connection with payment transactions;
store the account number in the memory device as a blocked account number;
receive a request to verify a new payment transaction as not being associated with the blocked account number, wherein the verification request includes a candidate account number;
compare the candidate account number to the blocked account number; and
deny the new payment transaction when at least a portion of the candidate account number matches the blocked account number.

9. A system in accordance with claim 8 wherein the computing device is further configured to receive an authorization request from at least one of a merchant and a merchant bank, the authorization request including the request to verify a new payment transaction, the new payment transaction initiated by the user using the payment card.

10. A system in accordance with claim 8 wherein the computing device is further configured to receive a clearance request from at least one of a merchant and a merchant bank, the clearance request including the request to verify a new payment transaction, the new payment transaction initiated by the user using the payment card.

11. A system in accordance with claim 8 wherein the account number to be blocked is a PAN, and the computing device is further configured to deny the new payment transaction when the candidate account number matches the PAN.

12. A system in accordance with claim 8 wherein the account number to be blocked includes a BIN, and the computing device is further configured to deny the new payment transaction when a first portion of the candidate account number matches the BIN.

13. A system in accordance with claim 8 wherein the computing device is further configured to deny the new payment transaction based solely on at least a portion of the candidate account number matching the blocked account number.

14. A system in accordance with claim 8 wherein the new payment transaction is at least one of a card-present transaction, a card-not-present transaction, and a card-not-present transaction that is recurring.

15. A system in accordance with claim 8 further comprising an account number blocking module in communication with the computing device, the account number blocking module being configured to:
compare the candidate account number to the blocked account number; and
determine whether at least a portion of the candidate account number matches the blocked account number.

16. Computer-readable storage media having computer-executable instructions embodied thereon for denying a payment transaction initiated by a user using a payment card associated with a blocked account, wherein when executed by at least one processor associated with a computing device and a memory device, the computer-executable instructions cause the at least one processor to:
receive a request to block an account number from being used in connection with payment transactions;
store the account number in the memory device as a blocked account number;
receive a request to verify a new payment transaction as not being associated with the blocked account number, wherein the verification request includes a candidate account number;
compare the candidate account number to the blocked account number; and
deny the new payment transaction when at least a portion of the candidate account number matches the blocked account number.

17. The computer-readable storage media of claim 16, wherein the computer-executable instructions also cause the processor to receive an authorization request from at least one of a merchant and a merchant bank, the authorization request including the request to verify a new payment transaction, the new payment transaction initiated by the user using the payment card.

18. The computer-readable storage media of claim 16, wherein the computer-executable instructions also cause the processor to receive a clearance request from at least one of a merchant and a merchant bank, the clearance request including the request to verify a new payment transaction, the new payment transaction initiated by the user using the payment card.

19. The computer-readable storage media of claim 16, wherein the account number to be blocked is a PAN, and wherein the computer-executable instructions cause the at least one processor to deny the new payment transaction when the candidate account number matches the PAN.

20. The computer-readable storage media of claim 16, wherein the account number is a BIN, and wherein the computer-executable instructions cause the at least one processor to deny the new payment transaction when a first portion of the candidate account number matches the BIN.

21. The computer-readable storage media of claim 16, wherein the computer-executable instructions further cause the at least one processor to deny the new payment transaction based solely on at least a portion of the candidate account number matching the blocked account number.

22. A system for denying a payment transaction initiated by a user using a payment card associated with a blocked account, said system comprising:
a memory device;
a computing device coupled to the memory device; and
an account number blocking module coupled to the computing device, the account number blocking module configured to:
receive a request to block an account number from being used in connection with payment transactions;
store the account number in the memory device as a blocked account number;
receive a request to verify a new payment transaction as not being associated with the blocked account number, wherein the verification request includes a candidate account number;
compare the candidate account number to the blocked account number; and
deny the new payment transaction when at least a portion of the candidate account number matches the blocked account number.

23. A system in accordance with claim 22, wherein the account number blocking module is further configured to receive an authorization request from at least one of a merchant and a merchant bank, the authorization request including the request to verify a new payment transaction, the new payment transaction initiated by the user using the payment card.

24. A system in accordance with claim 22, wherein the account number blocking module is further configured to receive a clearance request from at least one of a merchant and a merchant bank, the clearance request including the request to verify a new payment transaction, the new payment transaction initiated by the user using the payment card.
